(19) United States
(12) Patent Application Publication
(10) Pub. No.: US 2024/0409240 A1
(43) Pub. Date: Dec. 12, 2024

(54) Expendable Multistage Pressure-Fed Ablative-Cooling Nontoxic Non-Heavy Launch Vehicle

(71) Applicant: Tardigrade Space Systems LLC, Newtown, CT (US)

(72) Inventors: Sergii FAKAS, Kharkiv (UA); Michael L. CARPENTER, Cleveland Heights, OH (US); Aleksei PARNOWSKI, Kyiv (UA); Mykhailo GRECHUKHIN, Kyiv (UA)

(73) Assignee: Tardigrade Space Systems LLC, Newtown, CT (US)

(21) Appl. No.: 18/390,538

(22) Filed: Dec. 20, 2023

Related U.S. Application Data
(63) Continuation of application No. 17/666,612, filed on Feb. 17, 2022, now abandoned.
(60) Provisional application No. 63/147,259, filed on Feb. 9, 2021.

(51) Int. Cl. B64G 1/00; B33Y 80/00; B64G 1/40

(52) U.S. Cl. CPC B64G 1/002; B64G 1/401; B33Y 80/00

(57) ABSTRACT

An expendable launch vehicle is provided using pressure-fed liquid propellant fixed steering ablatively-cooled rocket engines. The vehicle is manufactured minimizing toxic or exotic metals and maximizing the use of conventional, inexpensive composites and 3D printed parts. Fuselage, fairing, stage shells, adapters, propellant tanks, and even engine combustion chambers are unified for all stages, are ablatively cooled, and, like the fairing, integral propellant tanks and adapters, are made of composites or 3D printed parts. Using non-toxic materials with non-toxic by-products, and non-toxic fabrication methods, using mostly non-metallic components allows for an environmentally neutral design.

### COPYRIGHT NOTICE

Pursuant to 37 C.F.R. 1.71 (d)-(e) (1988), a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATIONS

The present application claims the benefit of U.S. Provisional Application No. 63/147,259, filed on Feb. 9, 2021, and incorporated by reference as if fully rewritten herein.

### BACKGROUND OF THE INVENTION

### 1. Field of the Invention

The present invention relates to launch vehicles and, more particularly, to a simple, disposable, low toxicity, mass-producible, multistage, configurable launch vehicle made mostly of composites and within which the propulsion system is fixed mounted, ablatively cooled, and utilizes-pressurized fuel and oxidizer feed systems. The unique combination of the ablatively cooled engine coupled with the pressurized feed system eliminates the need for most pumps within the Launch vehicle (LV). By eliminating pumps in the LV, the overall LV reliability is greatly improved and the cost is reduced. The turbopumps typically used in liquid fueled rockets are one of the most expensive and maintenance intensive components. This enables more frequent launches in a wider range of weather conditions. The propellant choice for the preferred embodiment of the present invention is aviation grade kerosene (fuel) and high purity hydrogen peroxide (oxidizer) hereinafter referred to as “High Test Peroxide (HTP). In combination with its ablative method of engine cooling, this propellant scheme will produce less environmental impact than any other launch vehicle. The overall simplification of the LV increases safety as a result of the elimination of the high-pressure pumps, and fixed mounting of the engines results in removing substantial amounts of moving parts. Pumping fuel and oxidizers under high pressure is inherently dangerous and this danger is eliminated in the present invention. Additionally, range and launch pad safety are improved as a result of the elimination of toxic and corrosive fuels.

While individually, these concepts are known, they have heretofore not been combined in the novel fashion as presented herein. There is a long-felt need for LV systems that are substantially lower in cost than the current technological approaches can offer. The unique characteristics of the present invention allow for these efficiencies to occur. Further objects of the present invention are to provide LV's that are safe to operate, environmentally neutral, and lower the cost of participation to allow a wider range of end users with LV capabilities.

### 2. Description of the Related Art

There is a growing need in the space field for medium payload weight (1000-5000 kgs) launch vehicles (“LV's”) for transport and, in particular, a need to reduce the costs of satellite development and deployment, particularly of small satellites. The current state-of-the-art in the design and manufacturing of launch vehicles relies on the extensive use of costly materials and complex components. Such launch vehicles either are prohibitively expensive or require a design capable of being reusable in order to lower the cost per launch.

In addition to cost and toxicity, another fundamental problem of existing launch vehicles is that chemical rocket engines, either liquid-fueled or solid-fueled, have almost reached the physical limits of their effectiveness. Further improvements of prior art designs are generally along the same lines, and specifically including reusable space launch vehicles, increase complexity and launch costs and keep in place the substantial, and in practice often insurmountable, barriers to entry for various entities considering launching payloads.

The cost, complexity, waiting times, and toxic material content of current launch vehicle designs prevent most available payloads from being launched. This creates preventive and substantial barriers for launching space assets for many nations and organizations. The solid or liquid propellants employed, as well as some materials in the construction of the launch vehicles, are toxic in significant proportion, limiting launches due to potential impact on environmental and range safety (surrounding area) and limiting the viable locations for spaceports. Additionally, many of these materials are regulated and difficult to transport and store.

Existing LVs are developed using effectiveness, defined by the industry as “the efficiency of the power,” as the primary optimization criterion. Because of the physical limits existing for the chemical rockets, improving engine effectiveness increases rocket complexity and increases costs exponentially in the development, manufacturing and operation of the rocket, and the overall launch vehicle and associated processes as well. Most effective fuels are either cryogenic, which means high cost of operations, or highly toxic, or both, which makes these LV's even more expensive and dangerous. The dangers of these fuels also set additional limits on safe, ethical and regulated viable launching sites (not unlike airports, where you would not site a launch facility in the middle of a heavily populated area). More effective rocket engines are very complex, employing sophisticated turbo-pumps operating simultaneously with high-pressure, very high-temperature, and aggressive oxidizer gases, a combination in which regular steel will sublime directly to gaseous form. Aside from the loss of structural strength of the motor components, the gaseous metal vapors in the exhaust stream can be toxic and/or carcinogenic themselves.

Reusable LVs would seem to be a solution, but, in fact, are even more expensive in development, and require still more sophisticated technologies and materials and supporting operations. Reusable LVs impose higher operational costs, as was transparently illustrated by the U.S. Space Shuttle program. These arguments demonstrate a long-standing need for a low-cost LV with a simplified engine/fuel system that can be mass produced, has minimal environmental impact, has increased safety and reliability in operation due to inherent design, uses inexpensive easy-to-handle fuel/oxidizer, and is low cost to produce. The present invention meets these criteria and provides a singular solution to all these salient requirements. It satisfies the long-standing need for a safe low-cost launch vehicle by unique combination of technologies in an unanticipated form.

While many LV options exist for comparable payloads, they all have substantial drawbacks. Many are solid rocket boosters, which are highly toxic and dangerous. Others utilize toxic and exotic metallic materials. Still others require unusual launch conditions that increase cost and complexity as many use cryogenic components.

Consequently, needs exist for providing alternative LV's that are simultaneously simple, reliable, relatively inexpensive, range-safe, lightweight, mass-producible, low-toxicity, multistage, disposable, and are intended to be easily demonstrably treaty-compliant at all stages of its life cycle. Further, the need also exists to minimize reliance on any regulated components. The only regulated component of the present invention is the Hydrogen Peroxide.

### SUMMARY OF THE INVENTION

It is the object of the present invention to provide launch vehicles that are sustainable, inexpensive, have minimal effect on the environment, and are capable of effective performance in a broad range of use cases that utilize a novel collection of techniques to achieve these characteristics.

Further objects of the present invention are to provide LV's that are safe to operate, environmentally neutral, and lower the cost of participation to provide a wider range of end users with LV capabilities

The primary features for achieving the stated goal of the present invention are a combination of several key enabling technologies, those being: the use of decomposition products of the oxidizer and compressed gasses to pressurize the oxidizer tanks and the fuel tanks respectively; the use of ablative cooling of the engine; implementation of steering during the launch phase by selective throttling of individual or clusters of the fixed main engines, and/or selective firing and/or throttling of the auxiliary and steering engines; and, use of composite materials and advanced manufacturing processes wherever possible.

It is another feature of the present invention to provide a LV that minimizes reliance on regulated components such as certain fuels, oxidizers and mechanical components. The only regulated component in the present invention is the H₂O₂ oxidizer. The presence of any regulated component in the launch vehicle carries an administrative burden which multiplies as the number of regulated components increases.

Briefly described according to a preferred embodiment of the present invention, an inexpensive, expendable multistage launch vehicle is provided using pressure-fed liquid propellant rocket engines, which utilize kerosene as fuel and H₂O₂ (HTP High Test Peroxide”, defined herein as hydrogen peroxide having a concentration in excess of 75%) as oxidizer, respectively, which collectively shall be referred to as “propellant”. The vehicle is manufactured using minimal amounts of toxic materials or exotic metals, and maximizes the use of conventional, inexpensive composites and, where practical, 3D printed parts. The design of the engine combustion chambers is the same for all stages, with only the nozzles being different. The fairing, integral propellant tanks and adapters may all be made of lightweight low-toxicity composites or, where practical, 3D printed parts. It is recognized that metal parts can be used as well or if needed.

The launch vehicle uses products of H₂O₂ decomposition for pressurization of the oxidizer tanks, and the launch vehicle is steered by small impulse steering engines and/or fixed mono-propellant rocket engines, which use the reaction of H₂O₂ decomposition in conjunction with the possible addition of fuel such as kerosene to create thrust. The use of such a combustion system creates relatively low maximum pressures (i.e., about 300-1500 PSI/2-10 MPA). The launch vehicle avoids the use of any cryogenics and high pressure turbo pumps, and the launch vehicle has few moving parts (predominantly valves) which allows for minimization or elimination of exotic or hazardous materials in a low-cost lightweight high-reliability design. This engine design provides a “soft launch” vibration profile which is desirable for certain types of payloads.

It is the intent of the present invention to provide an environmentally neutral design, using non-toxic materials, with low or non-toxic by-products, and non-toxic fabrication methods, using mostly non-metallic components. It is recognized that while it may not be possible to be fully non-toxic, the present invention represents, perhaps, the lowest toxicity design of any launch vehicle attainable.

An advantage of using decomposition products of the oxidizer and compressed gasses to pressurize the oxidizer tanks and the fuel tanks respectively eliminates the need for and cost of high pressure turbopumps commonly found in prior art liquid fueled LV designs.

Advantages of using ablative cooling eliminates both the waste heat from combustion and the extensive cooling systems and their associated pumping and radiator systems normally found in prior art LV designs. This provides significant savings in cost and reliability, the increased reliability due to the elimination of the pumps and cooling systems, reduced cost as a result of the elimination of pumps and cooling systems, and increased payload and/or range, also due to the elimination of the pumps and cooling systems (for a given launch weight).

An advantage of steering during the launch phase by means of selective throttling of individual or clusters of the fixed main engines, and/or selective firing and/or throttling of the auxiliary and steering engines, is that it eliminates the need for gimbaled engine mounts and their associated cost, complexity, and unreliability.

An advantage of using composite materials and advanced manufacturing processes wherever possible allows for lower weight and reduced cost of the LV, and further provides increased payload and/or range

While individually, these concepts are known, they have heretofore not been combined in the novel fashion as presented herein. There is a long-felt need for LVs that are three (3) to ten (10) times lower in cost than the current technological approaches can offer. There is also a long-felt need for LVs that have minimal environmental impact, a feature lacking in the prior art. The unique characteristics of the present invention allow for these efficiencies and improvements to occur.

Another advantage of the present invention is that the only regulated element is the high concentration H₂O₂ oxidizer, being regulated only due to its concentration (i.e., >90%) and poses a hazard (if not properly managed) only when it decomposes and releases free O₂ and hot steam.

Yet another advantage of the present invention allows for compliance with the various treaties and regulations including, inter alia, enabling practical lower regulated tolerances for negative environment consequences and other forms of toxicity from launch activities, avoiding the creation of space debris with safe controlled destruction.

Further features of the invention will become apparent in the course of the following description.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side elevational cross section schematic of a launch vehicle according to a preferred embodiment of the present invention;

FIG. 2 is an aft plan view thereof;

FIG. 3 is a cross sectional view taken along the line B-B of FIG. 1;

FIG. 4 is a cross sectional view taken along the line C-C of FIG. 1;

FIG. 5A and FIG. 5B are schematic views depicting second stage steering for use therewith;

FIG. 6A and FIG. 6B are schematic views depicting first stage steering for use therewith; and

FIG. 7 shows details of the ablative cooling system.

### DESCRIPTION OF THE PREFERRED EMBODIMENTS

The best mode for carrying out the invention is presented in terms of its preferred embodiment, herein depicted within the Figures. It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112 (f).

The best mode for carrying out the invention is presented in terms of its preferred embodiment, depicted herein within the Figures.

### 1. Detailed Description of the Figures

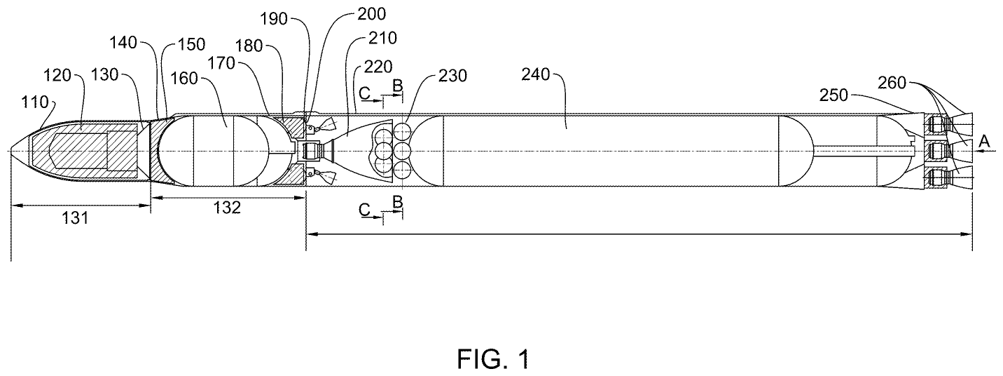

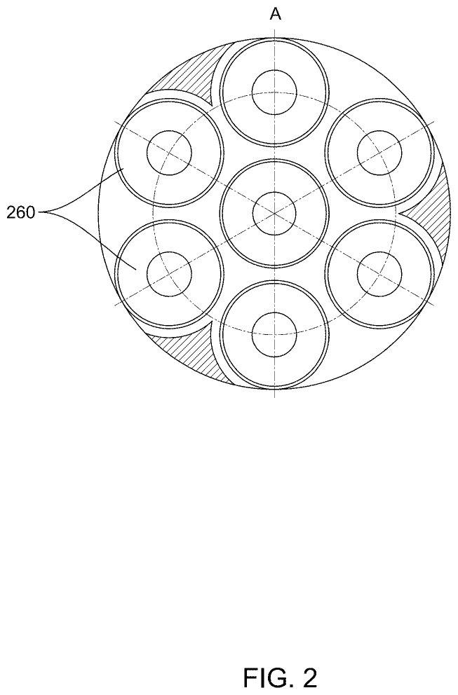

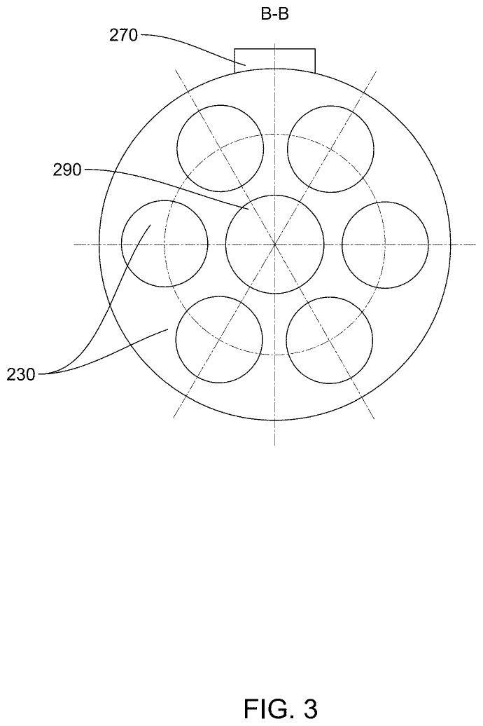

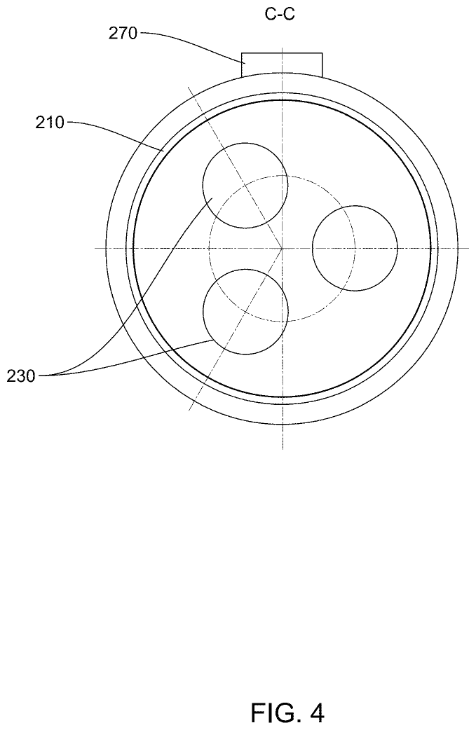

Referring now to the drawings, wherein like reference numerals indicate the same parts throughout the several views, a launch vehicle (“LV”), generally noted as 100, is shown according to a preferred embodiment of the present invention. A general layout of the launch vehicle (“LV”) 100 is shown best in FIGS. 1, 2, 3, and 4. While these figures show a cylindrical vehicle, such a design should not be considered limiting and a tapered configuration in which the various sections have different diameters or any other reasonable shape should be considered to be functional equivalent, with design differences mainly being in the mass and aerodynamics. The LV 100 may consist of the upper stage 131, the second stage 132, and the first stage 242, connected electrically by cables, running through a cable grove 270. Additional stages and/or strap-on boosters may also be featured in more advanced alternate configurations.

The LV 100 upper stage 131 (shown here as unpowered) includes a payload fairing (“fairing”) 110 adapted to protect a payload 120 and other elements of the upper stage 131. The fairing 110 provides a housing formed preferably of composite materials. The use of composites provides sufficient structural integrity of an otherwise disposable component without the use of potentially toxic metallic materials. The fairing 110 circumscribes and protects the payload 120, the payload adapter 130 and any other elements of the upper stage 131 (if present). While the payload 120 is anticipated as being variably selected by the launcher of the vehicle, it is anticipated that a non-passenger payload of about one or more metric tons may be accommodated. The upper stage 131 may include additional elements including, but not limited to, a space tug which can be designed using the same or different technology as the LV 100.

As would be apparent to one having ordinary skill in the relevant art, considering the present teachings and disclosures, the payload 120 capacity may change depending on a number of variables, including the desired orbit requirements, oxidizer concentration, payload characteristics, location of the launch site, ascent trajectory, presence of a space tug and its capabilities, etc. Further, it would also be apparent to the person of ordinary skill that different propellants may be used with this LV design, presuming appropriate changes are made to accommodate the differences in the materials from the baseline kerosene/H₂O₂ design.

A payload adapter 130 may be provided for mating the payload 120 to a second stage 132. The adapter 130 may further be formed of composite materials and affixes the payload 120 to the second stage 132 of the launch vehicle 100 until a payload separation. At an apex terminus of the second stage 132 an instrument compartment 140 may be included housing instruments (sensors and/or avionics and/or additional integrated payloads) 150. The instruments 150 may be selected for or vary by a selected mission profile. The instruments 150 may provide modules/logic/circuitry to receive images and/or provide the necessary trajectory, orientation or speed of the LV 100. A number of modular systems for avionics are available for launch system low-earth-orbit space launch that utilize such inputs. By way of example, and not meant as a limitation, U.S. Pat. No. 10,669,045 teaches one such Guidance, Navigation and Control systems (GNCs) that may be utilized.

The second stage 132 may further include various propulsion elements. The second stage propellant tanks 160 provide a pair of propellant containment volumes. The tanks 160 affix to a second stage tail section 170 that provides structural support for the second stage engine 210. The tail section 170 may further incorporate steering and stage separation engines 180, used for separating from the first stage 242. A second stage pressurization system 190 may include a gas generator and pressurized tanks utilizing decomposition of high-test peroxide (“HTP”). Further, steering monopropellant engines 200 may be used for steering of the LV and utilizing thrust from HTP decomposition. A second stage main engine 210 may provide a primary propulsion method for the second stage.

It is noted that the monopropellant engines typically run on the decomposition elements of H₂O₂. They differ from the main engines in this fashion and the fact that they do not add kerosene to the combustion mixture and thus produce less thrust. The steering engines do not require as much thrust as the main engines, thereby enabling a simpler design.

An interstage 220 may be provided to separate the second stage 132 from the first stage 242. The interstage 220 is a connecting element of the fuselage of the LV that makes an aerodynamic joint between the first stage 242 and the second stage 132 and circumscribes the second stage main engine 210 the second stage steering engines 180, the oxidizer tank cap 290 and the first stage pressurization system 230). It may be, and usually is jettisoned after separation of the first and second stages.

The first stage 242 may also further include various propulsion elements. A second stage pressurization system 230 may include a pressurized tank of a neutral gas (e.g. helium, nitrogen, other) for pressurizing the fuel, with the first stage propellant tanks 240 providing a pair of propellant containment volumes. The tanks 240 affix to a first stage tail section 250 that provides structural support for the first stage engine 260 for providing primary propulsion of the LV. The pressurization systems are used to pressurize the fuel and oxidizer tanks.

Additional launch facilitation components may also be provided, such as a cable groove 270, launch pad connectors 280 and oxidizer tank cap(s) 290.

The overall vehicle design as provided herein further allows for manufacturing using conventional, inexpensive composites and 3D printed parts if desired or more traditional metal-based methods if needed or desired. The main physical parameters for the preferred embodiments are shown below in Table 1 for the cylindrical configuration using 90% HTP oxidizer. It is noted that the optimal size of the LV varies with the concentration of the oxidizer.

TABLE 1
LV Specifications

| Parameter | 1^{st} stage | 2^{nd} stage | Total |
|---|---|---|---|
| Height*, m | ~8 > 25 | ~10 > 30 | ~20 > 50 |
| Diameter, m | ~2.5 > 4 | ~2.5 > 4 | ~2.5 > 4 |
| Total mass, kg | | | ~120,000 > 500,000 |
| Payload Mass, kg | | | ~800 > 5000 |
| Tank pressure, | 3-5 | 3-5 | |
| MPa | | | |
| # of Engines | 4-9 | 1-5 | |
| Propellant*** | H₂O₂ (90%, | H₂O₂ (90%, | |
| | 1392 kg/m³) + | 1392 kg/m³) + | |
| | Jet A-1, 815 | Jet A-1, 815 | |
| | kg/m³ | kg/m³ | |
| Burn Time, s | 90-240 | 90-300 | |
| Burns | 1 | 2-3** | |

Notes:
*The design allows for additional stages which increases the height, mass, and other salient characteristics of the LV.
**Until propellant is expended. Final burn may be used for controlled de-orbit.
***Other propellants may be used.
**** It is noted that these specifications are only presented as exemplars of one possible embodiment of the present invention.

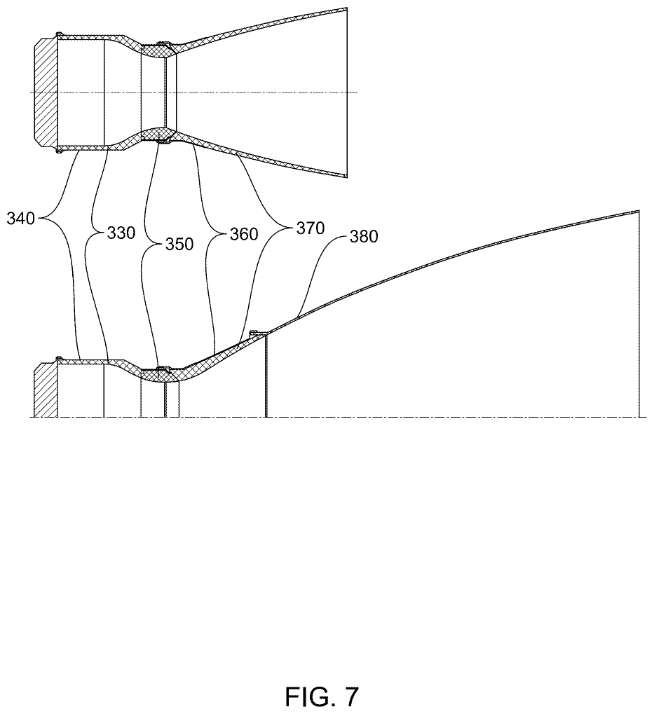

A key component of the present invention is its incorporation of ablative cooling. As shown best in conjunction with FIG. 7, instead of providing a heat transfer medium which must be pumped at a significant rate, as is common practice in liquid fuel rockets, the inside walls of the engine and nozzle may be designed to absorb the heat and then slough off as required. In particular, the inner surface of the critical section 350 of the combustion chamber and the nozzle are the places with the highest thermal loading. These can be built with ablative liners of just the base material from which the chamber 330 and nozzle 370 are formed. This is due to the fact that these components only have to successfully operate for about 300 seconds, after which they are no longer needed. Suitable ablative materials include, but are not limited to, metals, composites (including carbon-carbon and crushed fiberglass), ceramics, certain forms of graphite, etc. When actually in use, a tremendous amount of thermal energy is carried off by the materials ablating from the engine. Prior art in liquid-fueled engines employ high-rate cooling systems with complicated pumping systems and limited ability to throttle engines. In such scenarios the failure of a pump can result in the complete failure of an engine, which in turn can result in the failure of the LV. Such pumps are also maintenance, cost, and reliability concerns. The incorporation of ablative cooling reduces the cost, reduces the complexity, increases the reliability and increases the payload capacity of the LV for a given launch weight.

In the present invention, each engine comprises an injection head that may be formed on heat-resistant steel or stainless steel or other metals or ceramics as are deemed appropriate. As shown in FIG. 7, an outer shell extends distally from the injection head and may also be formed of heat resistant steel or stainless steel. Using ablative cooling, an ablative protector 330 and a fairing base 340 may be molded of a fiberglass-resin composite. A critical section 350 may be formed of a carbon-carbon composite, with a nozzle outer shell 360 also being formed of heat-resistant steel or composites. A nozzle ablative protector 370 may also be formed of a molded fiberglass-resin composite, with a vacuum nozzle extension 380. Similarly, the fairing, integral propellant tanks, and adapters, may all be made and are made of such composites or 3D printed parts or may be made of metal.

In operation, the launch vehicle of the present invention in any configuration utilizes the decomposition of the H₂O₂ oxidizer to pressurize the oxidizer storage tanks, and where decomposition provides primary and vectoring thrust during ascent. The vehicle may thereby be steered by small impulse steering engines and/or fixed mono-propellant rocket engines, which use the H₂O₂ decomposition reaction to produce thrust.

The decomposition of the oxidizer may be accomplished catalytically. A typical catalytic decomposition may use a silver screen that the oxidizer passes through. This may be located in the first portion of the injector assembly. The bulk of the oxidizer passes through to the injectors and then the combustion chamber. There may be one or more catalytic decomposition units per injector. Further, there may be one or more additional catalytic decomposition units as gas generators for pressurization of the oxidizer tanks. It is noted that the catalyst is preferably specific to the selected oxidizer in use. It is also noted that there may be more than one viable catalyst for a given oxidizer. For example, while silver is typically used for decomposing H₂O₂, any of several permanganates may also be used for this purpose. Similarly, the catalyst does not have to be in the form of a screen but may be formed in any number of other physical catalyst configurations while still providing a functionally equivalent operation.

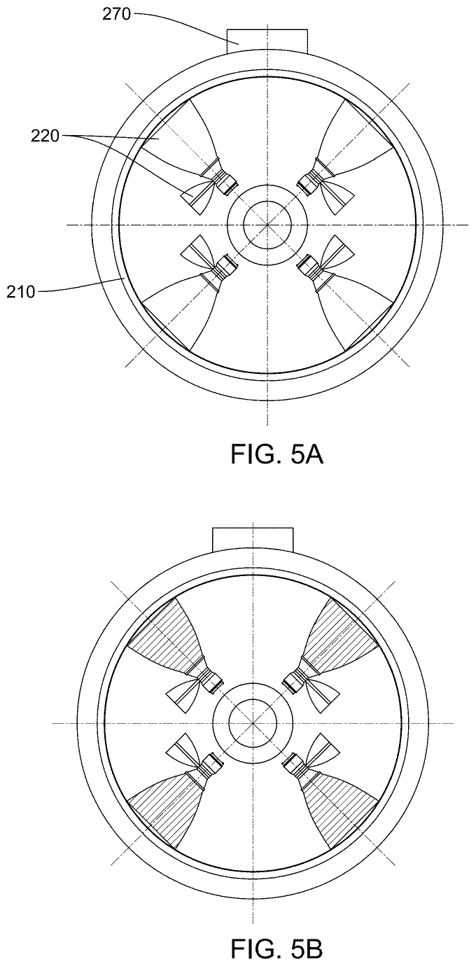

In this preferred embodiment a first stage configuration may be designed using seven engines, where each of the seven main engines 400 is anticipated to produce over 725 kilonewtons of thrust at sea level in the first stage. Such a design produces a total of about 5 meganewtons across all engines using about 301 tons of oxidizer and about 44 tons of fuel. A second stage engine 405 is anticipated to produce about 951 kilonewtons of thrust in vacuum. An auxiliary engine 410 may also be located on the second stage, to allow for fine-tuning the attitude of the second stage and allows the second stage to be used as a “space tug” or service vessel. It is noted that there are additional small engines on the second stage for control of Steering, Roll, Yaw, and Pitch (SPYR) as shown best in conjunction with FIGS. 5a and 5b. In more advanced configurations, it is envisioned that the second stage may be refueled and/or re-nozzled (replacement of the nozzle) and/or rechambered (replacing the combustion chamber) while in orbit so as to function for use after payload delivery.

The use of such a combustion system creates relatively low maximum pressures (i.e., about 300-1500 PSI/2-10 MPA), along with the absence of any cryogenics and having few moving parts allows for minimization of exotic or hazardous materials. This feature provides for “soft launch” vibration profiles for delicate payloads.

### 2. Steering, Pitch, Yaw, and Roll Control

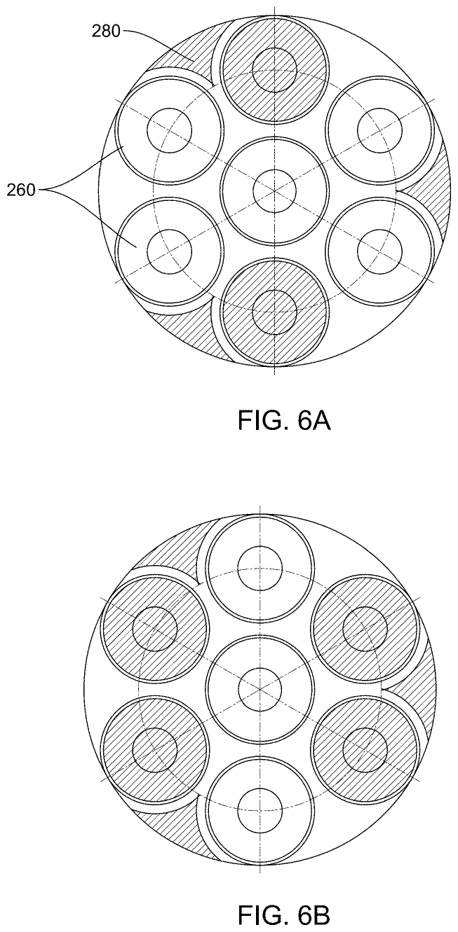

As best shown in conjunction with FIG. 6a and FIG. 6b, the present invention may further incorporate the use of fixed engines that are fired selectively individually or in groups to achieve the functions of Steering, Pitch, Yaw and Roll. Various combinations of engines and specific thrusts and timing of each engine/group may be used to create different thrust vectors and to maneuver the LV. In contrast, prior art designs may use gimbals to physically change the orientation of the engine relative to the major axis of the LV in order to achieve thrust vectoring. The use of a gimbal controlled system has disadvantages including: increased mechanical complexity; incorporation of extremely expensive moving parts; and the inclusion of flexible fuel and oxidizer lines. All of these conventional features add significant cost and reduce the reliability factor of a LV.

### 3. Operation of the Preferred Embodiment

It is noted that the present invention can perform the function of a launch vehicle in two or more stages for payloads of varying sizes and in useful orbits including Low-Earth Orbit, Polar Orbit, Sun-Synchronous Orbit, High-Earth Orbit, Geo-Synchronous Orbit and the International Space Station or any similar altitude destination. The present invention may further provide for delivery of payloads to standard orbits. The present invention may alternately be configured for suborbital payload delivery. The present invention is preferably intended to be safe for sustained high-frequency launch operations near population centers and other areas that need to be protected from harm in the event of a range safety event. The present invention is further designed to be capable of viable sustained launch operations in a wider range of launch environments and under a wider range of temperature and inclement conditions, including maximizing safe available launch days per year as compared to prior art launch vehicles, and needing simpler and shorter pre-launch checks than prior art LVs. The present invention uses pressure-fed liquid propellant rocket engines, which can utilize kerosene and H₂O₂ (HTP High Test Peroxide) as fuel and oxidizer respectively, with the products of H₂O₂ decomposition being also used for pressurization of oxidizer tanks.

The present invention is intended to set a ‘low bar’ for cost of launch. Various common composites are used in manufacture, with no exotic, toxic, rare, or cryogenic materials are required. Fixed mounted engines eliminate expensive and heavy gimbal mounting systems. No high pressure turbopump systems are used to deliver the fuel and oxidizer, and the ablative cooling of the engine and elimination of the gimbaled engine mounts eliminates a large number of expensive parts normally found in prior art LVs. Such a launch vehicle differs from the closest competing launch vehicles, which do not share any salient characteristics of propulsion, cooling, construction, and other key elements with this design that is capable of launch and range safety with much less space. In order to result in an inexpensive launch vehicle, complex and hazardous operations were minimized, such as cryogenics, pumps and other moving parts. Further, minimizing those items that are unreliable or regulated reduces the overall cost per launch. Finally, the present propulsion source is generally 30-95% less expensive than conventional prior art alternatives, as well as being environmentally friendly and safe.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this Patent Application.

What is claimed is:

1. An expendable launch vehicle having at least one stage and comprising, in combination:
at least one pressure-fed liquid propellant rocket engine utilizing kerosene and High-Test Peroxide with a concentration greater than 75% as fuel and oxidizer, respectively; and
at least one fuel tank, wherein pressurized gasses pressurize said at least one fuel tank;
at least one oxidizer tank, wherein products of H₂O₂ decomposition pressurize said at least one oxidizer tank; and
at least one fixed mounted engine adapted to be ablatively cooled; wherein a controlled firing and/or throttling of said at least one fixed mounted engines is used to effect steering of the launch vehicle.

2. The launch vehicle of claim 1, wherein said at least one fixed mounted engine further comprises an ablatively cooled combustion chamber system capable of maintaining pressure up to 20 MPa.

3. The launch vehicle of claim 1, further comprising a plurality fixed mounted engines adapted to be ablatively cooled and wherein a controlled firing and/or throttling of one or more said engines is used to effect steering of the launch vehicle.

4. The launch vehicle of claim 1, further comprising, in combination:
at least one impulse steering engines utilizing a discharge of products of H₂O₂ decomposition to create thrust.

5. The launch vehicle of claim 2, further comprising, in combination:
at least one impulse steering engines utilizing a discharge of products of H₂O₂ decomposition to create thrust.

6. The launch vehicle of claim 1, further comprising a fuselage made from a composite material.

7. The launch vehicle of claim 6, where at least one fuel tank and at least one oxidizer tank are integrated into walls of the fuselage.

8. The launch vehicle of claim 2, further comprising a plurality fixed mounted engine adapted to be ablatively cooled and wherein a controlled firing and/or throttling of one or more said engines is used to effect steering of the launch vehicle.

9. The launch vehicle of claim 2, further comprising, in combination:
at least one impulse steering engines utilizing a discharge of products of H₂O₂ decomposition to create thrust.

10. The launch vehicle of claim 3, further comprising, in combination:
at least one impulse steering engines utilizing a discharge of products of H₂O₂ decomposition to create thrust.

11. The launch vehicle of claim 2, further comprising a fuselage made from a composite material.

12. The launch vehicle of claim 11, where at least one fuel tank and at least one oxidizer tank are integrated into the walls of the fuselage.

13. The launch vehicle of claim 2, further comprising at least a second stage coordinating with a first stage, said second stage including:
an apex terminus housing at least one instrument and at least one sensor providing measurement and control of a trajectory, an orientation, and a speed of the launch vehicle; and
a second stage pressurization system including at least one pressurized tank utilizing decomposition of high-test peroxide; and
at least one fixed mounted second engine comprising an ablatively cooled combustion chamber capable of maintaining pressure up to 20 MPa.

14. The launch vehicle of claim 1, in further combination with a launch vehicle launching system, wherein said launch vehicle and said launching system are adapted to utilize low toxicity materials and employ low toxicity processes having reduced toxicity in the operation, byproducts and effects.
and effects.
